(19) United States
(12) Patent Application Publication
(10) Pub. No.: US 2007/0083642 A1
(43) Pub. Date: Apr. 12, 2007

(54) Fully distributed data collection and consumption to maximize the usage of context, resource, and capacity-based client server interactions

(75) Inventors: Richard Alan Diedrich, Rochester, MN (US); Jinmei Shen, Rochester, MN (US); Hao Wang, Rochester, MN (US)

Correspondence Address: IBM CORPORATION, 3605 HIGHWAY 52 NORTH, DEPT 917, ROCHESTER, MN, 55901-7829, US

(73) Assignee: International Business Machines Corporation, Armonk, NY (US)

(21) Appl. No.: 11/246,822

(22) Filed: Oct. 7, 2005

(51) Int. Cl. G06F 15/173

(52) U.S. Cl. 709/224

(57) ABSTRACT

A method, distributed-computing system, and computer program product for providing efficient workload management within a distributed computing environment. Each device within the distributed-computing environment is enhanced with a workload management controller (WLMC) functionality/utility, designed specifically for the type of device (i.e., client WLMC versus server WLMC) and utilized to collect process data about the particular device (e.g., status information) and about the device's interaction with the network. With the localized device-based WLM Controllers, each device utilizes fully distributed tagged information to accomplish capacity-based routing, context-based routing, and resource-based routing without any overhead or loss of data and without any network congestion. The distributed WLM Controller model enables each device to operate without concern for the level of CPU usage or memory usage of the particular device.

### BACKGROUND OF THE INVENTION

1. Technical Field

The present invention relates generally to computer systems and in particular to distributed computer systems. Still more particularly, the present invention relates to efficient data collection within distributed computer systems as well as context-/resource-/capacity-based routing and dynamic workload management.

2. Description of the Related Art

Client-server distributed computing is becoming the standard computing topology because of quickly-evolving Internet development and associated e-practices, i.e., e-commerce, e-business, e-health, e-education, e-government, and e-everything practices. Client-server distributed computing is becoming even more important with the expansion of Web Services and grid utility computing.

Workload management is a key activity of distributed computing and the most important part of modern e-infrastructure. Conventional workload management in distributed computing has progressed through three different models. In a first model, a monitoring system (i.e., an attached computer system) collects data and the system administrator reviews the collected data to administrate the various computing devices. For example, a DB2 server stores a large amount of data, including query access plan and statistics for each table. However, with this first model, the DB2 server is not utilized to complete workload management and/or context-sensitive application routing.

In the second model, illustrated by FIG. 2, a client (computer system) collects data to aid an executing application to find/determine the best server to route its communication (data). Examples of systems implementing this second stage method are the smart client in Bea System's Web Logic and Microsoft's smart .NET client. As shown in FIG. 2, client 205 comprises WLMController (WLMC) 210, which operates within client 205 to collect data, such as response time, from each server 215 so that a next request from client 205 will be sent to the most responsive server 215.

Finally, in the third model, illustrated by FIG. 3, one server 316 (or elected entity) acts as a centralized WLMController 312 to collect data and manage all servers 315 so that client 305 will route its communication according to instructions received from this central WLMController 312. One example of the application of this third model is eWLM of International Business Machines (IBM). WebSphere workload management is also configured according to this model, where the deployment management acts as the central WLM controller.

Each of the above methods exhibit limitations that lead to inefficiency and in some cases bottlenecks in the overall system. For example, the first model is a manual process (i.e., no automatic collection and use of collected data) and is therefore not appropriate for current on-demand computing environments. Further, smart client (utilized by Bea Systems and Microsoft) of the second model utilizes only single client data, which is typically skewed due to problems already existing in the communication channels that are being monitored. Further, in typical systems, a single server may serve millions of clients, and the server life is substantially longer than client life, which is typically very short, (e.g., client life of 10 minutes compared with server life of 365 days). Thus client monitoring includes no history of the external network/system from which smart decisions may be made. Also, smart client is not able to complete context-based routing since smart client does not receive sufficient amounts of context data from across the system.

With the third model, the centralized controller needs to exchange data among all servers managed by the centralized server. The centralized server thus creates huge overhead and occasionally malfunctions when CPU-usage is high (e.g., over 90%) or memory usage is high. A list of limitations of a centralized controller also includes occasional congestion of the network, routing oscillation for dynamic WLM, single-source point of failure across the system (i.e., having one bad server operate as a single point of failure), and long latency when processing data at the central controller before transmitting the result to a requesting client. This last limitation is particularly troublesome in real-time on-demand systems. For example, in some applications, centralized WLM controller always delivers server weight too late in key time when server CPU usage is above 90% and/or server memory usage is above 90%. This late delivery occurs because the server is not able to receive timely weights from centralized WLM controller. Elected central controller produces the same problem, which is yet unresolved. Thus, to prevent this occurrence, server vendors typically advise their customers not to put too much load on servers and maintain 30-80% workload. This restriction/limitation on the server reduces server resource utilization and cause server instability.

With further application of Internet-based methods for more-efficient and expansive distributed computing environments (client-server computing), smart WLM becomes more and more important. However, as described above, previous workload management techniques have various limitations/inaccuracies that reduce the effectiveness of the computing environment. Companies are thus investing large amounts of money and resources on eWLM and other similar products, although the above described problems are yet unresolved.

### SUMMARY OF THE INVENTION

Disclosed are a method, distributed-computing system, and computer program product for providing efficient workload management within a distributed computing environment. Each device within the distributed-computing environment is enhanced with a workload management controller (WLMC) functionality/utility, designed specifically for the type of device (i.e., client WLMC versus server WLMC) and utilized to collect process data about the particular device (e.g., status information) and about the device's interaction with the network. With the localized device-based WLM Controllers, each device utilizes fully distributed tagged information to accomplish capacity-based routing, context-based routing, and resource-based routing without any overhead or loss of data and without any network congestion. The distributed WLM Controller model enables each device to operate without concern for the level of CPU usage or memory usage of the particular device.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram representation of a data processing system within which various embodiments of the invention may be implemented;

FIGS. 2 and 3 are block diagrams of prior art representations of a WLM Controller within a distributed computing environment;

FIG. 4A is a block diagram of a distributed-computing environment with distributed WLM controllers according to one embodiment of the invention;

FIG. 4B is a block diagram of a client and server with respective WLM controllers collecting localized-device data according to one embodiment of the invention;

FIG. 4C is an exemplary WLM result table generated by a combination of data from multiple WLMCs across the distributed computing environment according to one embodiment of the invention; and

FIG. 5 is a flow chart of one embodiment of the process of workload management within the distributed-computing environment of FIG. 4A.

### DETAILED DESCRIPTION OF AN ILLUSTRATIVE EMBODIMENT

The present invention provides a method, distributed-computing system, and computer program product for providing efficient workload management within a distributed computing environment. Each device within the distributed-computing environment is enhanced with a workload management, controller (WLMC) functionality/utility, designed specifically for the type of device (i.e., client WLMC versus server WLMC) and utilized to collect process data about the particular device (e.g., status information) and about the device's interaction with the network. With the localized device-based WLM Controllers, each device utilizes fully distributed tagged information to accomplish capacity-based routing, context-based routing, and resource-based routing without any overhead or loss of data and without any network congestion. The distributed WLM Controller model enables each device to operate without concern for the level of CPU usage or memory usage of the particular device.

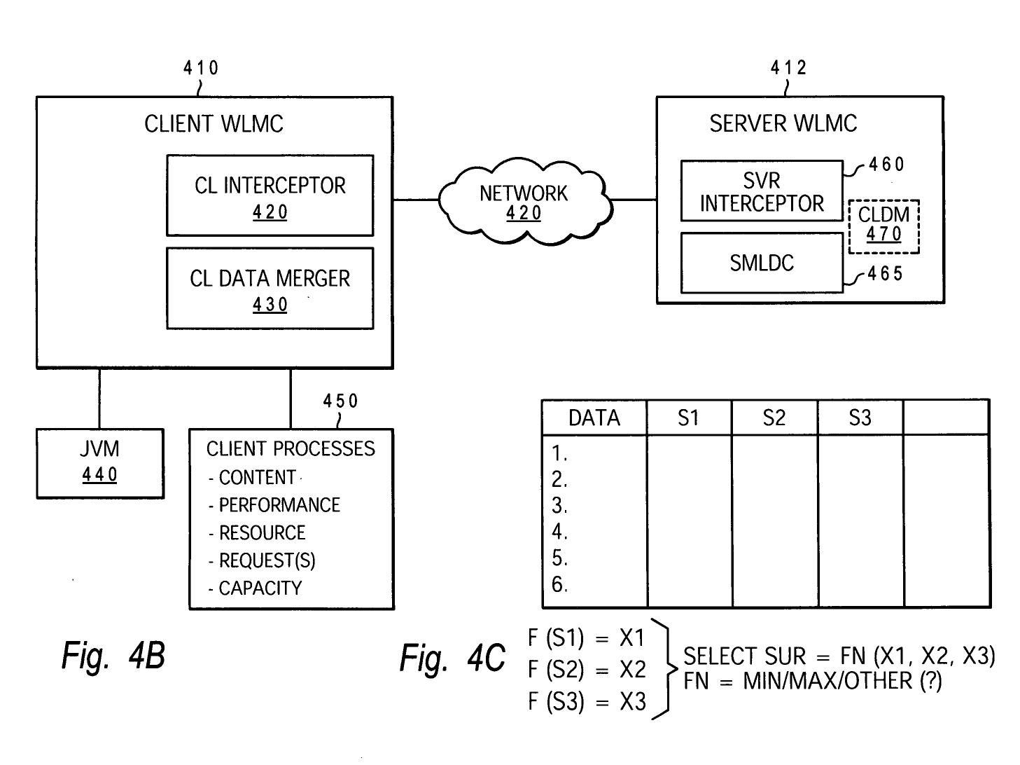

With reference now to FIG. 4A, there is depicted an exemplary distributed-computing environment configured according to one embodiment of the invention. Distributed-computing environment 400 comprises client 405 coupled to a plurality of servers 415 via a network 420 (illustrated as a network cloud). Client 405 comprises a workload management controller (WLMC) 410 and each server 415 also comprises a WLMC 412. For simplicity in describing the different functions between the WLMC operating at client 405 from that operating within servers 415, the former WLMC is described as client WLMC and the latter WLMCs are described as server WLMC. However, one skilled in the art appreciates that a single utility may provide both client and server WLMC functions and is configured to support the particular device within which the utility is being installed and/or executed.

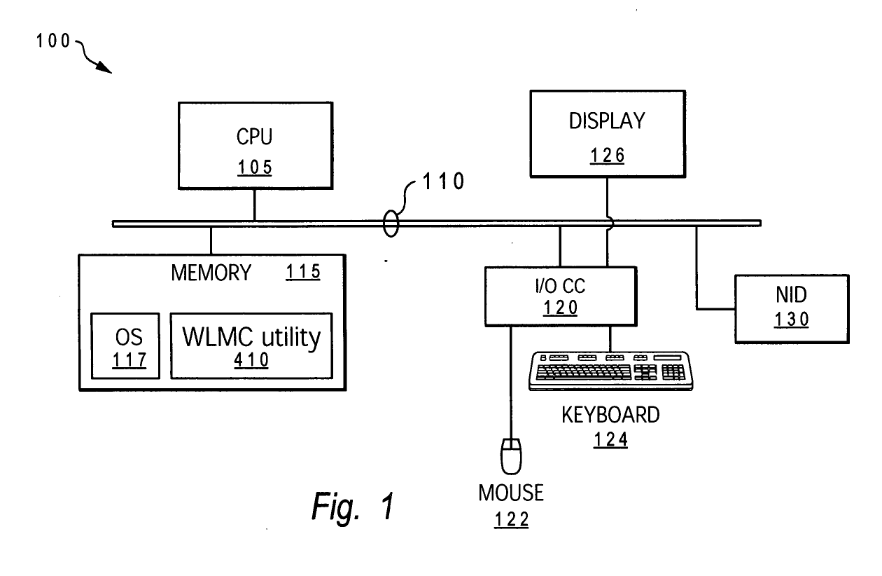

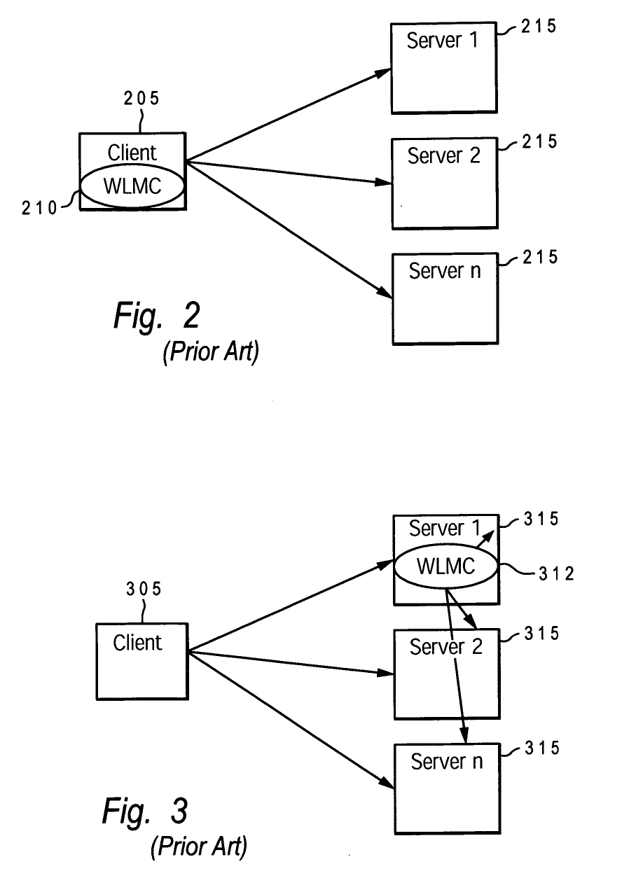

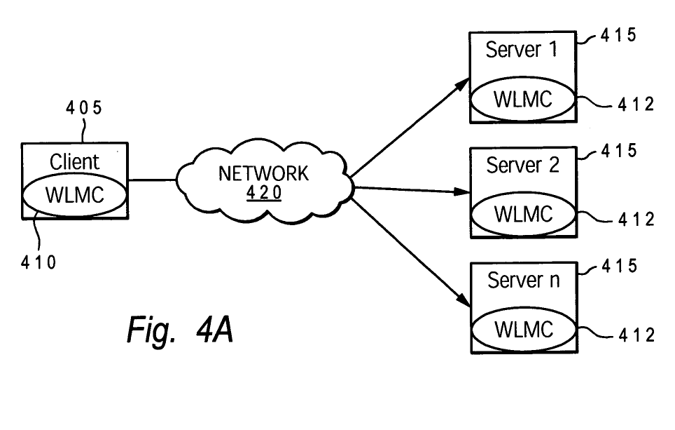

Referring now to FIG. 1, there is illustrated a data processing system, which may be utilized as either client 405 or server 415, depending on the programming of the particular data processing system. Data processing system 100 includes processor (central processing unit) 105, which is coupled to memory 115, input/output (I/O) controller 120. and network interface device (NID) 130 via system interconnect 110. NID 130 provides interconnectivity to an external network, such as illustrated by FIG. 4A. I/O controller 120 provides connectivity to input devices, of which mouse 122 and keyboard 124 are illustrated, and output devices, of which display 126 is illustrated. Other components (not specifically illustrated) may be provided within/coupled to data processing system 100. The illustration is thus not meant to imply any structural or other functional limitations on data processing system 100 and is provided solely for illustration and description herein.

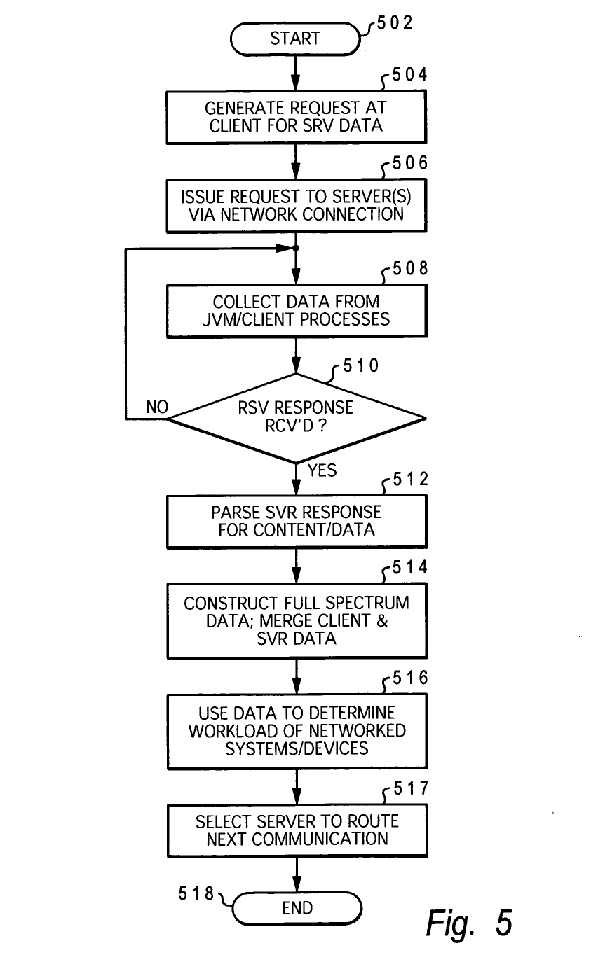

In addition to the above described hardware components of data processing system 100, several software and firmware components are also provided within data processing system 100 to enable the computer system to complete the device monitoring services, data collection, and routing server selection processes described herein. Among these software/firmware components are operating system (OS) 117 and WLMC utility 410. WLMC utility 410 is illustrated within memory 115. However, it is understood that, in alternate embodiments, WLMC utility 410 may be located on a removable computer readable medium or be provided as a component part of OS 117. When executed by processor 105, WLMC utility 410 executes a series of processes that provides the various functions described below, with reference to FIGS. 4B-4C and 5.

FIG. 4B provides an expanded view of software components of client 405 and server(s) 415 within the fully-distributed WLMC model, according to one embodiment of the invention. Implementation of the illustrated embodiment includes several software (and software-controlled hardware) components, which are now described. WLM controller 410/412 is provided within client 405 and server 415, respectively. WLMC is a fully-distributed service that merges and collects data from the WLMC's own JVM 440 or from the WLMC's (or device's) own process(es). As shown, client processes 450 include/provide content data, performance data, resource data, client request data, and capacity data, which are all collected within the client's own process.

Server WLMC 412 comprises server interceptor 460, which is a utility that is registered with each server to perform injection of server data into a response stream being sent to the client following receipt of a client request. Client interceptor 420 on the other hand is found within client WLMC 410 and is utilized to extract client request context, input the client request context to the router (connecting client to the network), and inject the client request context to the client's request stream.

In addition to server interceptor 460, server WLMC 412 also comprises Server Monitor and Local Data Collector (SMLDC) 465, which collects performance, capacity, and content data of the server's processes. Then, these locally collected server data are injected into the response stream through server interceptor 460.

Client Processes 450 may be processes within JVM 440. Additionally, client WLMC 410 may also be a component within JVM 440 or one of client processes 450. When the functions are provided within a Java environment, a process may sometimes be equal to JVM; however, the features of the invention may be implemented in environments utilizing C++ processes or processes provided by other programs.

Finally, client data merger 430 is a utility that merges data from the response streams of all servers to construct the full spectrum data. For example, as shown in FIG. 4C, after client 405 issues three requests to server1, server2, and server3 415, client 405 is able to build workload overview data from a combination of client's own recorded data (sensed by client) and data received from server1, server2, and server3 415, in respective response streams. An exemplary table and associated workload calculation function is also illustrated by FIG. 4C, which shows the collection of multiple data for each of the servers and ultimate use of the collected date to determining which server to utilize for routing data/information form the client.

Referring again to FIG. 4A, in the fully-distributed model a WLMC utility is provided within all clients and all servers. Each WLMC collect data from its local device, which data may be stored within the device's JVM (java virtual machine). When a client request is sent to a server, the server pushes server-collected data to the requesting client in a response stream. With the configuration illustrated by FIG. 4A, for example, the client is able to obtain information from all servers (along with the client's own information) by issuing only three requests to the three connected servers. The process is completed in an effective and efficient manner without any server-to-server WLM controller messages and without any additional traffic and messages on the network.

In one embodiment, the subsequent client request may also bring new merged data in the client side through client interceptor 420, and the server interceptor 460 peaks out these client-merged data and merges the client-merged data with the server's local data. This embodiment provides another cluster data merger component (CLDM) 470 in the server WLMC 412, which is not required for the other described embodiments. With this embodiment, however, all servers 415 are provided each others complete information without direct communications among servers 415 and without a centralized controller. For example, after three requests, client 405 has received all information of Server1, Server2, and Server3 415 in addition to client 405 information. With the fourth client request, client 405 connects to Server1, and Server1 gets all information of client 405, Server2 (415), and Server3 (415) through this client 405 because the client 405 also brings in client's merged information to Server1 (415). In the next/subsequently-issued two requests, Server2 and Server3 also obtain the complete merge information, similar to Server1.

Accordingly, the fully-distributed design operates as an on-demand system, where servers only push directed information out to the network when the client requests that information. The client, meanwhile, is able to obtain all required content and context information to complete the client's scheduling and other processes by simply issuing a number of requests. Among the information obtained by the client are: (1) server capacity information to complete CPU/memory-based routing and provisioning; (2) server content to complete content-based routing; (3) client context to complete context-based routing; and (4) server resource to complete resource-based routing.

Thus, as depicted, the distributed model does not include a centralized controller and thus avoids overhead and congestion. The distributed model also does not malfunction when CPU/memory usage is high. The distributed WLMC controller model of the illustrative embodiments thus unifies and provides all of the above functions and features in a single utility.

According to the illustrative embodiments, a fully-distributed Client-Server WLMC method is provided that maximizes client-server interactions and resolves a substantial majority of previous problems found with single-WLMcontroller implementations. The fully-distributed WLM model allows the client to receive substantially more information, not only from its own monitoring/sensing of the network, but also from server-collected data. According to the illustrative embodiment, among the additional data retrieved from the server WLMCs are server-context (or resource) and server-content. Since a single server is able to serve millions of clients and the server life is significantly longer than client life, enabling the client to retrieve additional data from the server that have been accumulated for a long time by the server enables the client to perform/calculate more accurate analyses of workload management and routing-server selection.

The distributed WLMC method enables the client to be able to collect various kinds of client request contexts and information in addition to the client itself sensing network data/information. This further enables the client to perform context-based routing, which requires the client possess knowledge of the whole spectrum of request context, which the client is conventionally unable to experience. The use of a fully-distributed WLMC mechanism also provides the functionality of: (1) avoiding the congestion of the network; (2) avoiding routing oscillation with delivery of dynamic WLM; (3) avoiding having a single bad device that provides a single point of failure; (4) avoiding the long latency of having a single server with real-time on demand system; and (5) provide early delivery of server weight even when the server's CPU usage is above 90% or the server's memory usage is above 90%.

The invention does not provide any significant overhead at any one point since the management load is distributed throughout the system. According to the illustrative embodiment, the fully-distributed model substantially eliminates the need to exchange single messages between servers, and thus the model results in substantially no overhead. Thus, the fully-distributed model (design) remains functional even when CPU usage is 100% and/or memory usage is 100%. Further, the fully-distributed model utilizes both server capacity data and server content and client context data. Additionally, the fully-distributed design utilizes millions of other clients' context data in addition to the context data of the requesting client.

In one embodiment, a fully distributed client-server WLM mechanism that maximizes client-server interactions is provided. The client system collects data both from the client's own monitoring function as well as data received from each of the servers (collected at the server). The client pulls data from the server, where the data has accumulated from a long period of time by the server, with server-context and server-content (historical data). The client also collects all kinds of client request contexts and information to enable the client to complete context-based routing (knowing the whole spectrum of existing request context).

FIG. 5 is a flow chart of the process linking the above components and/or utilities to provide fully-distributed WLM control at the client. The process begins at initiator block 502 and proceeds to block 504, which illustrates the client generating a request for server data. The client then issues the request to the specific server(s) via the network, as shown at block 506. The client also collects data from the JVM and/or the client's processes, as indicated at block 508. The collection of data from the client's own processes is ongoing, and thus the client may simply forward the collected data to a central utility for combination with server data and/or for processing.

The client waits on return of the server(s) response(s) to the client's request, and WLMC utility determines at block 510 whether the server(s) response(s) have been received. When server response(s) are received, the WLMC utility parses the response for server content/data at block 512, and the WLMC utility constructs a full spectrum data by merging/combining the client data with the received server data at block 514. The WLMC utility evaluates the combined data to determine the overall workload of the network systems/devices at block 516, and then the WLMC utility selects (at block 517) one of the servers, using the corresponding workload calculations for each of the multiple servers, as the server to which a next client communication is routed through the network. The process then ends at block 518.

By utilizing the fully-distributed design of the illustrative embodiments, the client is able to intercept and inject and transport WLMC data between client and server. The above described features of the invention may be implemented in one of several ways, depending on the protocol being utilized. These protocols and associated mechanisms include: (1) in http protocol by http filter mechanism; (2) in iiop protocol by CORBA ContextService mechanism; and (3) in straight java socket by writing Request/Response head with tagged information. The client completes these operations by (1) http filter for HTTP protocol; (2) Corba ContextService in iiop protocol; or (3) tagging to payload in any socket communication, each without modifying existing routing protocol. Thus, there is no requirement for changes to any existing protocol, i.e., no additional traffic is needed to transport WLMC data between client and server, since the WLMC data are tagged into the request/response stream as additional data.

As a final matter, it is important that while an illustrative embodiment of the present invention has been, and will continue to be, described in the context of a fully functional computer system with installed management software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard disk drives, CD ROMs, and transmission type media such as digital and analogue communication links.

While the invention has been particularly shown and described with reference to a preferred embodiment, it will be understood by those skilled in the art that various changes in form and detail may be made therein without departing from the spirit and scope of the invention.

What is claimed is:

1. A computing device comprising:
a processor and memory coupled thereto;
network connection facility for connecting the device to an external network
one or more processes executed by the processor and which generates client data;
a workload management controller (WLMC) executed by said processor that performs the functions of:
monitoring and collecting the client data from the one or more processes;
generating one or more requests for server data, each requests targeting a specific one of available servers;
issuing said requests to the network;
receiving a response for each request issued to the external network;
parsing each received response for server data associated therewith; and
merging said server data with said client data to generate a merged data; and
dynamically determining a network workload from said merged data and performing workload management across the computer network by providing context-resource-capacity-based network routing for network communication being transmitted from said device.

2. The device of claim 1, further comprising:
a java virtual machine (JVM); and
wherein said WLMC performs the functions of collecting said client data from one or more of (1) said JVM and (2) other processes of the device; and
wherein said first data comprises one or more of content data, performance data, resource data, client request data, and capacity data.

3. The device of claim 1, wherein said WLMC comprises a client data merger utility that merges the server data received within the response(s) received with the client data to construct a complete network spectrum of said merged data.

4. The device of claim 1, wherein:
said WLMC comprises a first interceptor facility that extracts client request context, inputs the context into an injection facility to inject the context into each request generated by the first device, wherein multiple requests are transmitted, one to each server on the network; and
said each request prompts for receipt of at least one of the following information from the specific second device: (1) server capacity information utilized to complete CPU/memory based routing and provisioning; (2) server content utilized for content-based routing; (3) client content utilized for content-based routing; and (4) server resource utilized to complete resource-based routing.

5. The device of claim 3, wherein said first interceptor facility injects the complete network spectrum of said merged data into said each request, said full spectrum including data from said device and from multiple existing servers within the computer network, whereby a second data merger utility within the server is able to merge the complete network spectrum of merged data with its server data to provide an updated complete network spectrum of said merged data that provides said server with complete network-level workload and routing information without a centralized controller.

6. The device of claim 1, wherein when said device is utilized as a server, said WLMC further comprises:
a server monitor and local data collector (SMLDC) facility that collects performance, capacity, and content data, as said server data, from server-level processes; and
wherein the interceptor facility performs an injection of said server data into a response being sent to a client device that issued a request for said server data.

7. The device of claim 1, wherein said WLMC function for combining client data and server data includes the function of generating fully-distributed tagged information to accomplish capacity-based routing, context-based routing, and resource-based routing, without any overhead, loss data, routing oscillation, single points of failure within the network, long latency of processing for real-time on demand system, and network congestion.

8. The device of claim 1, wherein said WLMC enables said device to intercept, inject, and transport WLMC data between said client and said server via one of: http filter for HTTP protocol; corba ContextService in iiop protocol; and tagging to payload in a socket communication, each without modifying existing protocol.

9. A computer program product comprising:
a computer readable medium; and
program code on said computer readable medium for providing a workload management controller (WLMC) that when executed by a processor of a computing device performs the functions of:
monitoring and collecting the client data from the one or more processes;
generating one or more requests for server data, each requests targeting a specific-one of available servers;
issuing said requests to the network;
receiving a response for each request issued to the network;
parsing each received response for server data associated therewith; and
merging said server data with said client data to generate a merged data; and
dynamically determining a network workload from said merged data and performing workload management across the computer network by providing context-resource-capacity-based network routing for network communication being transmitted from said device.

10. The computer program product of claim 9, further comprising program code that when executed by the processor provides the functions of collecting said client data from one or more of (1) a java virtual machine (JVM) operating on the computing device, and (2) other processes executing on the computing device, wherein said first data comprises one or more of content data, performance data, resource data, client request data, and capacity data.

11. The computer program product of claim 9, wherein said WLMC further comprises code for implementing a client data merger utility that when executed provides the function of merging the server data received within the response(s) received with the client data to construct a complete network spectrum of said merged data.

12. The computer program product of claim 9, wherein said WLMC comprises code for implementing a first interceptor facility that when executed provides the functions of:
extracting client request context, inputting the context into an injection facility to inject the context into each request generated by the device, wherein multiple requests are transmitted, one to each server on a network connected to the device; and
prompting, via said each request, for receipt of at least one of the following information from the specific second device: (1) server capacity information utilized to complete CPU/memory based routing and provisioning; (2) server content utilized for content-based routing; (3) client content utilized for content-based routing; and (4) server resource utilized to complete resource-based routing.

13. The computer program product of claim 11, wherein said first interceptor facility injects the complete network spectrum of said merged data into said each request, said full spectrum including data from said device and from multiple existing servers within the computer network, whereby a second data merger utility within the server is able to merge the complete network spectrum of merged data with its server data to provide an updated complete network spectrum of said merged data that provides said server with complete network-level workload and routing information without a centralized controller.

14. The computer program product of claim 9, wherein when said device is utilized as a server, said WLMC further comprises program code for implementing:
a server monitor and local data collector (SMLDC) facility that when executed performs the functions of collecting performance, capacity, and content data, as said server data, from server-level processes; and
wherein the interceptor facility includes the function of performing an injection of said server data into a response being sent to a client device that issued a request for said server data.

15. The computer program product of claim 9, wherein said WLMC code for providing the function of for combining client data and server data includes code for providing the function of generating fully-distributed tagged information to accomplish capacity-based routing, context-based routing, and resource-based routing, without any overhead, loss data, routing oscillation, single points of failure within the network, long latency of processing for real-time on demand system, and network congestion.

16. The computer program product of claim 9, wherein said WLMC code includes code for enabling said device to intercept, inject, and transport WLMC data between said client and said server via one of: http filtering for HTTP protocol; corba ContextService in iiop protocol; and tagging to payload in a socket communication, each without modifying existing protocol.

17. A distributed computer network comprising:
a first device having associated therewith a first work load management controller (WLMC) that monitors and collects first data from processes within the first device and generates requests for network-level data, which requests are issued to the network;
a second device communicatively couple to the first device via the computer network, said second device comprising a second WLMC, wherein the second WLMC provides second data corresponding to the second device and generates a response to a request received from the first device, said response having included therein the second data and, which is transmitted to the first device via the response; and
processing means associated with the first WLMC for combining the first data with the second data into merged data that is utilized to dynamically determine a network workload and provide workload management across the computer network by providing context-resource-capacity-based network routing for network communication being transmitted from said first client.

18. The distributed computer network of claim 17, wherein:
said first device collects said first data from one or more of (1) a java virtual machine (JVM) of the first device and (2) processes of the first device, and wherein said first data comprises one or more of content data, performance data, resource data, client request data, and capacity data;
said processing means of said first device comprises a client data merger utility that merges the second data received within the response received from the second device with the first data to construct a full spectrum of said merged data.
said first WLMC comprises a first interceptor facility that extracts client request context, inputs the context into an injection facility to inject the context into each request generated by the first device, wherein multiple requests are transmitted, one to each server-level second device on the network;
said each request prompts for receipt of at least one of the following information from the specific second device: (1) server capacity information utilized to complete CPU/memory based routing and provisioning; (2) server content utilized for content-based routing; (3) client content utilized for content-based routing; and (4) server resource utilized to complete resource-based routing;
the processing means for combining first and second data includes means for generating fully-distributed tagged information to accomplish capacity-based routing, context-based routing, and resource-based routing, without any overhead, loss data, routing oscillation, single points of failure within the network, long latency of processing for real-time on demand system, and network congestion; and
when said first device is a client and said second device is a server, without modifying existing protocol, said client intercepts, injects, and transports WLMC data between said client and said server via one of: http filter for HTTP protocol; corba ContextService in iiop protocol; and tagging to payload in a socket communication.

19. The distributed computer network of claim 18, wherein:
said first interceptor facility injects a full spectrum of said merged data into said each request, said full spectrum including data from said first device and from multiple existing second devices within the computer network; and
said second device comprises a second data merger utility that merges the full spectrum of merged data within the request received from the first device with the second data to provide an updated full spectrum of said merged data that is utilized to provide said second device full network-level workload and routing information without a centralized controller.

20. The distributed computer network of claim 17, wherein further said second device comprises:
a server monitor and local data collector (SMLDC) facility that collects performance, capacity, and content data, as said second data, from server-level processes; and
a second interceptor facility that is registered with the second device to perform an injection of said second data into the response being sent to the first device, wherein when said second device is a server, said second data is server-collected data.
